(19) United States
(12) Patent Application Publication
(10) Pub. No.: US 2004/0215712 A1
(43) Pub. Date: Oct. 28, 2004

(54) Wireless data server for transient clients

(76) Inventor: Michael Roy Henricks, Richardson, TX (US)

Correspondence Address: Michael Roy Henricks, 1 Shadywood Place, Richardson, TX, 75080, US

(21) Appl. No.: 10/410,862

(22) Filed: Apr. 11, 2003

(51) Int. Cl. G06F 15/16

(52) U.S. Cl. 709/203

(57) ABSTRACT

A system to distribute HTML, audio, and other data to transient computer clients. The system automatically downloads the data when the client is in range and prepares the data for display even when the user is out of the server's range. The invention includes the organization of the displayed data and a means to update and monitor the remote servers.

### RELATED PATENT APPLICATIONS

Not applicable.

### STATEMENT REGARDING FEDERALLY SPONSORED RESEARCH OR DEVELOPMENT

The inventor is not and has never been involved in any federally sponsored research or development.

### REFERENCE TO SEQUENCE LISTING, A TABLE OR A COMPUTER PROGRAM LISTING COMPACT DISK APPENDIX

Not Applicable.

### BACKGROUND OF THE INVENTION

The invention is in the field of computer science and applications pertaining to wireless networking, distributed computing, data display, and a unique model for serving HTML web pages. The specific achievements are providing geographically relevant information such as web pages or audio tracks to mobile computers that may be in the range of base stations for only a few seconds. Normally, dynamic web pages require a connection to the web server. Central to this invention is special server software on the client to serve data to web (HTML) browsers, games, and other programs. A mechanism for efficiently updating and monitoring the remote servers is a part of this invention.

### BRIEF SUMMARY OF THE INVENTION

A typical use for the invention is roadside informational or “historical” markers. A server located in the proximity of the marker provides an access point for any compatible wireless network capable mobile computer within range. While any client is connected to the network the server broadcasts the geographically relevant data. The clients download and verify the data. This could include web pages providing educational, commercial, or other useful information or data to be used by other applications such as geographically relevant games or travel logs. The data gathered from each base station is organized on the client into a growing, constantly updated set of data. The dynamic web site is navigated by selecting regions on sequentially larger scale maps. A lightweight HTML server running on the client computer displays the dynamic and static pages and performs searches and other scriptable tasks. The top-level web pages are dynamically generated and organized around the current location.

A mobile update computer driven along the same route may automatically monitor and update the distributed servers. It will upload the data files instead of download them. Digital signatures are used to authenticate the data packages.

### BRIEF DESCRIPTION OF THE SEVERAL VIEWS OF THE DRAWING

Not applicable

### DETAILED DESCRIPTION OF THE INVENTION

In the field, the system comprises two parts: the client and the server. A maintenance client is also used to manage servers in the field. The invention consists of the use of wireless networking to download geographically relevant data in the field and the Special Software necessary to perform the data transfer and prepare it for use on the client.

Server

The server is a computer with at least:

A compatible wireless networking hardware such as an 802.11 interface. The server should have “base-station” features such as a DHCP server, etc so clients without peer to peer capabilities can connect.

Special software to send the data to the client in a loop and respond to re-send requests.

Special software to accept connections from a maintenance client and download a new data using digital signatures for authentication.

Client

The client can be any computing device with:

A compatible wireless networking hardware such as an 802.11 interface that makes a connection whenever the client is in proximity to the server. Special software to receive data packets broadcast from the server, verify the packets and request packets be resent when necessary.

Special software to integrate the data into the previously downloaded data on the client.

The lightweight HTML server that uses the downloaded data to provide a mobile web-site with search capability.

A standard web browser to display content from the HTML server.

Other special software such as games to display or manipulate the downloaded data.

The Protocol

1. The server is loaded with the data package and running the wireless protocol and server software.

2. The client computer approaches. The client has its wireless network system on and is blocked on a receive call on the wireless network's broadcast port (UDP). When the client comes into range, the wireless protocol establishes a network connection.

3. When the server's network software connects to the client, it triggers the server software to begin broadcasting the sequence of data packets. The server continues to broadcast the packets in a loop while any client is still in the wireless network.

4. If the server is already broadcasting data, then the client accumulates packets until it has collected them all.

5. The client saves and verifies the data packets.

6. In the event of a bad or missing packet, the client opens a socket to the server on a well-known port and requests an out of order re-broadcast of the packet.

7. The potentially more powerful (due to transmission power, superior antenna, or other reason) server may continue to send packets to the client even after the client is too far away to successfully transmit back to the server.

8. The client may move out of the wireless network range.

9. The client verifies the data using the server's public key.

10. The client software processes the data to update the selection/navigation HTML pages with the new web site and geographical features like roads or towns, install/update the static web site, search capabilities, and other data for use on the client.

11. Web sites are placed in their own directories. The sites are grouped according to a grid such that, for example, all sites between 32° and 33° N and 28° and 29° W are in one directory. Each group includes the bitmap of the large-scale map that is updated with each website. The displayed large-scale web page is a composite of these bitmaps.

12. The user can browse the new pages or use the data in other applications like games or search engines.

Desktop links provide an internet URL directed at localhost:somePort for display by the client computer's Web Browser. The Special Software web server will be listening for HTML connections on somePort. The top level of the web site is a map of the entire region served. This might be a map of North America. By selecting the region of interest, user can navigate down to a page that displays the downloaded sites on a map. The map is updated to show each downloaded server. Selecting an individual site brings up its web site, which may include links to other pages.

Audio tours would download the relevant portion of the tour as user entered the new region.

Games and other educational tools would integrate the new data.

Maintenance Client

Maintenance clients can be any computing device with:

A compatible wireless networking hardware such as an 802.11 interface that makes a connection whenever the client is in proximity to the server.

Special software to track which servers made a connection and successfully uploaded their data.

Special software to connect to the server and upload new data.

Maintenance clients would be driven along an established route to maintain and monitor a set of remote servers. Instead of downloading data, a Maintenance Client computer records the connections to verify the servers are functioning. To update the servers, the Maintenance Client would upload the new data to the stationary server as it passed by. By placing the Programming Client on a vehicle with a regularly scheduled route, server availability can be monitored and content easily updated.

I claim my invention is:

1. A means to automatically transfer data from a wireless network server to a mobile client computer as it passes within range of a server.

2. The integration of the data received in (1) into a growing data set kept on the client computer.

3. A means to organize web pages gathered as in (1) into a cohesive web site using the geographical relationships of the sites to one another by grouping them according to a grid and updating a bitmap and HTML data to create a composite navigational display.

4. The use of “web-server” software running on the client to provide mobile access to the data organized in (3).

5. Using the data gathered in (1) for audio or text tour guides.

6. A means to monitor and update the remote server computers as in (1) via a moving maintenance client.

7. In (1), the use of a broadcast port on the wireless network to efficiently deliver the sequential data packets to multiple clients at once.

8. In (7), the use of individual sockets for each client to request the server re-send a missing or damaged packet.
